(19) United States
(12) Patent Application Publication
(10) Pub. No.: US 2004/0012125 A1
(43) Pub. Date: Jan. 22, 2004

(54) Blow molded fan shroud

(76) Inventors: William D. Plant, Anderson, SC (US); Stephen D. Hiltner, Ann Arbor, MI (US); Richard D. Rhodes, Somersworth, NH (US)

Correspondence Address: Steven J Grossman, Grossman Tucker Perreault & Pfleger, 55 South Commercial Street, Manchester, NH, 03101, US

(21) Appl. No.: 10/311,622

(22) PCT Filed: Jun. 19, 2001
(86) PCT No.: PCT/US01/19623

(51) Int. Cl. F28F 1/00; F28F 13/12; B29C 47/00

(52) U.S. Cl. 264/523; 165/41; 165/122

(57) ABSTRACT

A blow molded fan shroud (10) for use with an automotive cooling system is disclosed. The fan shroud (10) integrates a motor mounting ring or plate (20) for supporting a motor for driving the fan. The motor mounting ring or plate (20) is spaced from a front surface of the fan shroud (10) by a plurality of spiders (18). The spiders (18) are formed so as to include at least one portion with a hollow cross-section or chamber (22).

This invention relates generally to a fan shroud assembly for an automotive coolant fan, and more particularly to a blow molded automotive coolant fan shroud which integrates a motor mount into the fan shroud body, wherein said integrated motor mount comprises single-wall or double-wall construction and which attenuates motor vibration transmission. In addition, the present invention relates to a fan shroud that is simultaneously prepared with a separate bottle or container positioned in the center waste-area of the shroud, wherein the precursor parison used to prepare such shroud/bottle combination in a blow-molding operation can be programmed to form selected thicker wall sections as may be required for selected locations in the shroud construction. Furthermore, the present invention relates to the novel use of a die-trimming procedure as applied to a fan shroud blow-molded assembly which provides improved tolerances in the final product.

U.S. Pat. No. 5,649,587 discloses a blow-molded radiator fan shroud which provides an improved, compact and efficient blow-molded radiator fan shroud with integral fluid receptacles. Oppositely disposed recesses are formed in the front and rear faces to form a wall for dividing the hollow body into two or more internal chambers.

In addition, attention is directed to Tangue et al U.S. Pat. No. 3,692,004 which discloses a fan shroud and fluid receptacle arrangement including a cylindrical band or collar extending away from a radiator, and a radiator fluid receptacle and a windshield washer fluid receptacle integrally molded on opposite side surfaces of the cylindrical band or collar. Furthermore, attention is also directed to the following U.S. Pat. Nos. 3,833,054; 4,030,541; 4,709,757; 4,762,244; 4,763,724; 4,947,931 and 5,107,924.

Finally, attention is also directed to U.S. application Ser. No. 09/177,458, filed Oct. 22, 1998, owned by the assignee herein, which relates to the use of a fan shroud with an air intake arrangement.

In a fan shroud and receptacle arrangement for use adjacent a vehicle radiator and around one or more engine cooling fans, the improvement which comprises an integrated motor mount in the fan shroud body, wherein said integrated motor mount comprises double-wall construction, optionally compressed into a single layer, and wherein said double-wall construction can be adjusted by programmed parison formation in a corresponding blow-molding operation. In alternative embodiment, the present invention relates to the preparation of a fan-shroud assembly wherein the center waste-area of the shroud is simultaneously prepared with a separate bottle/container which bottle/container is not part of the final fan shroud, and which bottle may contain ribs or weirs to ultimately assist in dissolved gas removal to thereby improve the heat-transfer efficiency of the fluid to be contained therein. Finally, in alternative embodiment, the present invention relates to the use of additives in the plastic of the shroud which additives are designed to change color/shape based upon liquid temperature to thereby indicate coolant levels. Finally, the present invention also relates to all of the above embodiments, wherein the shroud is simultaneously designed to contain engine coolant liquid, and wherein the shroud contains air flow-through ducting, to thereby channel air for engine combustion and to improve the cooling of the engine coolant contained therein.

FIG. 1 illustrates a perspective view of the blow molded fan shroud of the present invention.

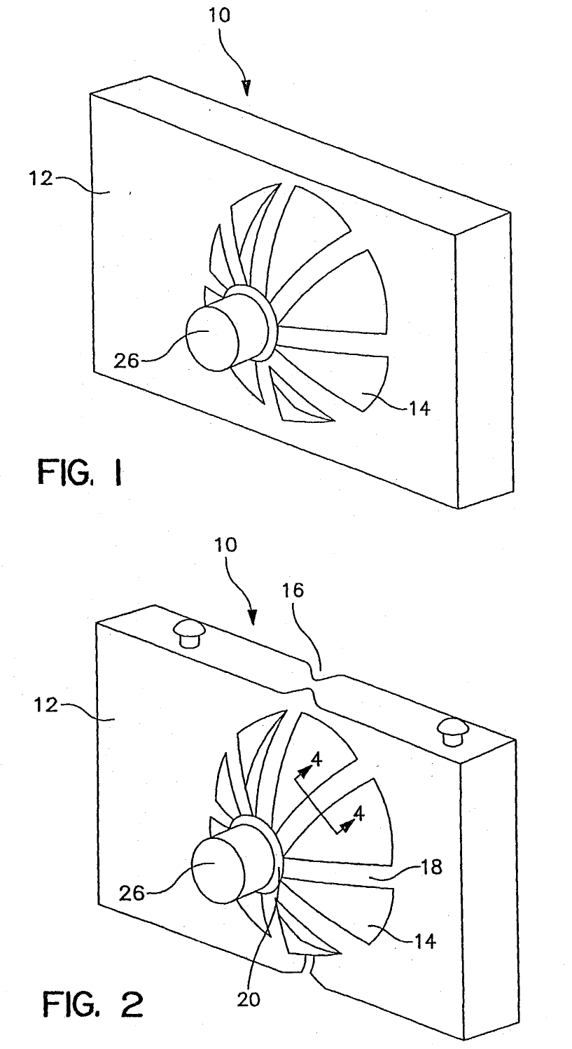

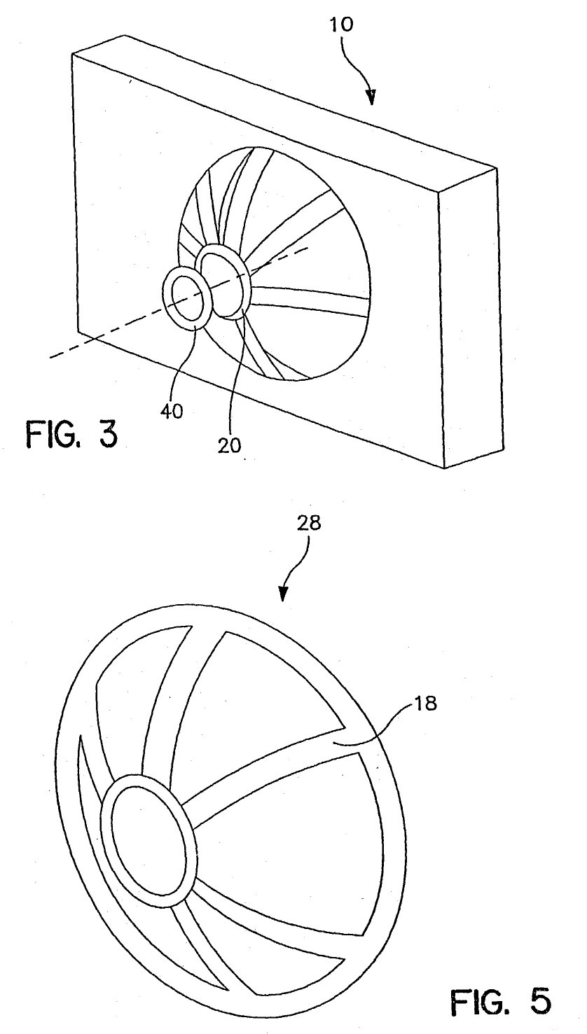

FIG. 2 illustrates in perspective view a second embodiment of the present invention.

FIG. 3 illustrates in exploded view the blow molded fan shroud and a reinforcing member.

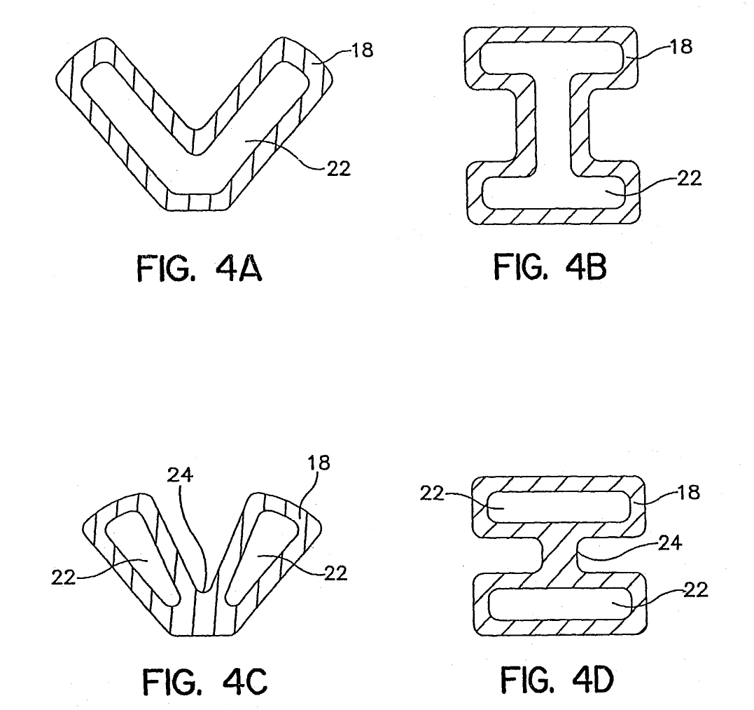

FIG. 4 illustrates in cross-section high section modulus profiles of spiders.

FIG. 5 illustrates in perspective view a separate spider assembly.

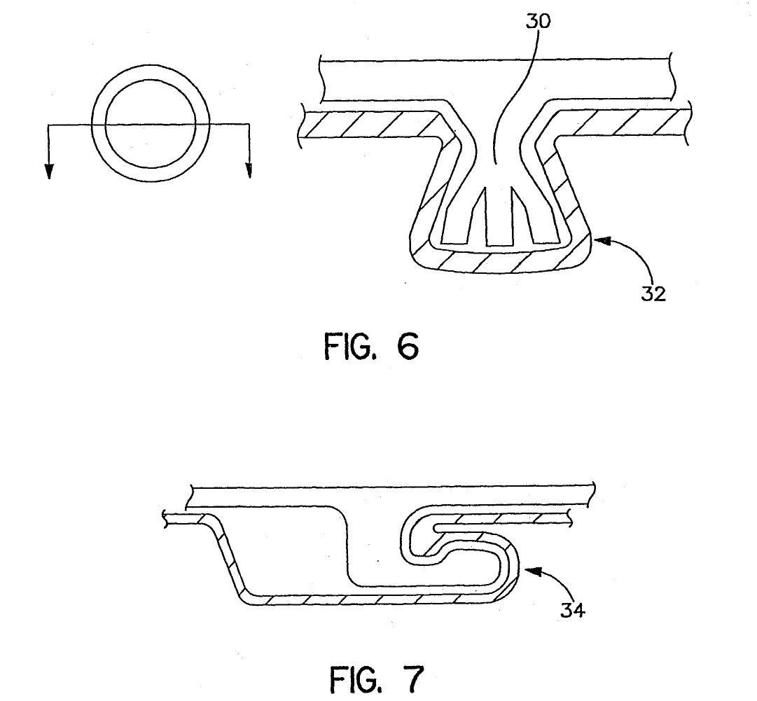

FIG. 6 is a cross-sectional view of a collapsible post and socket attachment means.

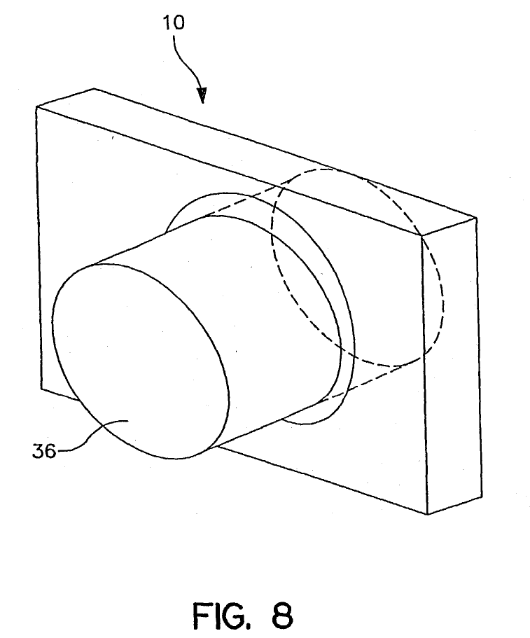

FIG. 7 is a cross-sectional view of the dovetail-twist lock attachment means.

FIG. 8 illustrates in perspective a third embodiment of the present invention.

With reference to FIG. 1, the present invention comprises a fan shroud 10 for use with an automotive cooling system. The fan shroud 10 comprises a hollow, double walled body of generally rectangular shape having a generally planar front face 12 and an opposed generally planar rear face. The fan shroud 10 contains an opening 14 through the body of the fan shroud 10 defined by a cylindrical wall. Alternately, the opening 14 may have a rectangular geometry on the front face that transitions to a circular opening on the rear face. The double walled construction of fan shroud 10 attenuates vibration transmission from the fan assembly. In the context of the present invention, vibration attenuation has reached levels of about 40%.

As shown in FIG. 2, preferably, the hollow, double-walled body of the fan shroud 10 is configured as a chamber, as for holding fluid. Alternately, the body of fan shroud 10 may be configured into multiple chambers through the use of pinch lines 16 sealing opposed walls together. Each chamber preferably includes appropriate openings and fittings necessary for filling, draining, and/or plumbing requirements depending upon the end use application of the chamber.

The opening 14 in fan shroud 10 may be configured to direct the flow of air from the fan 26 to the engine, to be employed, for example, for additional engine cooling or forced induction feed for engine combustion. The air stream from opening 14 may be directed by means of diffusers or deflectors positioned about the periphery of the opening 14. Alternately, the opening 14 may be fitted with ducting to communicate the air flow to appropriate secondary uses.

As illustrated in FIGS. 2-3, the fan shroud 10 further contains spiders 18 extending radially from the circumference of the opening 14 toward the normal axis of the opening 14. Spiders 18 are connected to a fan motor mounting ring or plate 20 that is positioned concentrically with opening 14. The fan motor mounting ring 20 preferably includes a reinforcing member 40. The reinforcing member may be disposed on the forward face of the fan motor mounting ring 20, on the rearward face of the fan motor mounting ring 20 as illustrated in FIG. 3, or it may be an insert-molded, integral component of the fan motor mounting ring 20. Preferably, reinforcing member 40 comprises a metallic member. Alternately, reinforcing member 40 may comprise a reinforcing structure, such as fiber reinforced plastic.

Preferably, spiders 18 are integral with fan shroud 10 as shown in FIG. 1, and are formed in the same blow molding operation as fan shroud 10. The concept of parison programming, i.e. forming the parison for the part with varying, and controlled, thickness about the length and circumference of the parison, is herein used to control the final thickness of the fan shroud 10 and of the spiders 18 formed therewith.

When spiders 18 are integrally molded with the fan shroud 10, spiders 18 may be formed as solid, or single walled members. Alternately, the strength of spiders 18 may be increased by forming the spiders 18 as hollow, double-walled members having at least one longitudinal hollow chamber 22 extending at least a portion of the length of the spider 18 by modifying the blow molding process. The structural integrity of spiders 18 may be further improved by molding spiders 18 in a high section modulus profile, for example a “V” or “I” cross-section, as shown in FIGS. 4A-4C. The high modulus profiles may therefore comprise a single continuous hollow chamber 22, or a plurality of hollow chambers 22 joined by regions of a pinch off 24. Preferably the profile or shape of spiders 18 is also configured to provide maximum aerodynamic flow through fan shroud 10.

When spiders 18 are formed integrally with fan shroud 10, the region defined by the perimeter of the opening 14 and adjacent spiders 18 will comprise a plurality of webs of material. To ensure proper removal of the webs, and concentric placement of fan assembly 26 within opening 14, it is preferred that all of the webs be removed in a single step trimming operation using a V-die trimming process. This trimming process allows exact placement of the fan within opening 14, therein allowing minimal clearance between the tip of the fan and the wall of opening 14. The reduced clearance achievable through die trimming provides overall increased efficiency of the cooling fan.

Stated another way, it has been found that die-cutting has a primary advantage in “relative” rather than “absolute” dimensioning. In the case of a fan-shroud, what is important is that the tip clearance of the fan be minimized to maximize cooling. Accordingly, it is more important to center the fan in the shroud than to consider where the fan is in space. This is best accomplished by referencing off the center of the fan motor mount for trimming. With water-jet or laser, the trimming is relative to an absolute locator somewhere on the holding fixture (all indirect referencing subject to variation).

In an alternative embodiment, illustrated in FIG. 5, spiders 18 may comprise a separately molded component 28 attached to fan shroud 10 during a secondary operation. Preferably, separately molded component 28 is injection molded from a reinforced plastic material, such as glass fiber reinforced nylon. In the interest of minimizing assembly parts, separately molded component 28 may be attached to fan shroud 10 using molded in securement means, for example collapsible post 30 and socket 32, or dovetail twist lock 34 fastening, as illustrated in cross-sectional views in FIG. 6 and FIG. 7 respectively. Corresponding male and female components of the molded in securement means are molded to the spiders 18 and the fan shroud 10 respectively. The joint may be further strengthened by assembling spiders 18 to the fan shroud 10 promptly after the fan shroud 10 is removed from the mold. As the fan shroud 10 shrinks during cooling the molded in securement means will tighten together providing a secure joint.

When the fan shroud 10 is to be provided with separately molded spider component 28 a web, or waste area, of material will be molded over opening 14 of fan shroud 10 as a natural product of the blow molding operation. The waste inherent in blow molding the fan shroud 10 may be reduced by molding a separate bottle 36 or reservoir, preferable a hot or pressurized bottle, in the center of the waste area or the fan shroud 10, as illustrated in FIG. 8. The size and shape of the bottle 36 is constrained only by the dimensions of opening 14, as illustrated in broken lines in FIG. 8. Furthermore, the thickness of the bottle 36 can be controlled using parison programming as described above. As an additional feature, if desired the bottle 36 may be molded with flow disrupters, such as ribs or weirs, to assist deaeration of the fluid in the bottle, and thereby increase the heat transfer efficiency of the fluid. After the fan shroud 10, containing the bottle 36, has been molded, the bottle 36 will be removed, as by V-die trimming, as a secondary process.

A final aspect of the present invention is the incorporation of a fluid level indicator integrated into at least one of the chambers of the fan shroud 10 or into the bottle 36 molded into the waste area of the fan shroud 10. The level of a fluid above ambient temperature, such as coolant, can be indicated using a reversible heat activated colorant. When the temperature of the coolant, and therefore the plastic, exceeds a predetermined magnitude the colorant is activated and the color of the plastic changes. The reversible nature of the colorant is such that when the coolant, and therefore the plastic, falls below the predetermined level the coloration reverses. In this manner, when the chamber or bottle is partially filled with fluid above the predetermined temperature, the portion of the chamber or bottle in contact with the fluid will appear as a different color than the portion of the chamber or bottle not in contact with the fluid above the predetermined temperature.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

We claim:

1. A fan shroud reservoir for holding a fluid, comprising:
a hollow structure formed of a moldable material having a reversible heat activated colorant.

2. The reservoir of claim 1, wherein the moldable material comprises a plastic.

3. The reservoir of claim 1, wherein the colorant causes the material to change color when the fluid in the reservoir exceeds a first predetermined temperature.

4. The reservoir of claim 3, wherein the colorant causes the material to return to an original color when the fluid temperature falls below a second predetermined temperature.

5. The reservoir of claim 4, wherein the first predetermined temperature is greater than the second predetermined temperature.

6. The reservoir of claim 1, further comprising air flow-through ducting in said fan shroud to channel air for engine combustion.

7. The reservoir of claim 1, further comprising air flow-through ducting in said fan shroud to improve the cooling of engine coolant contained within the reservoir

8. A fan shroud for a vehicle engine, comprising:
a fan shroud body 10 having an opening 14 extending from a front face 12 of the body to a rear face of the body, and
a plurality of radially spaced spiders 18 having first ends intergrally formed with and extending outwardly from the front face 12 of the fan shroud body about the periphery of the opening 14, the spiders 18 having second ends terminating in a motor mounting plate 20 displaced from the front face 12 of the body away from the rear face, wherein at least a portion of the spider 18 has a hollow cross section.

9. The fan shroud of claim 8, further comprising a plurality of deflectors positioned about the periphery of the opening 14 to direct the flow of air to the engine.

10. The fan shroud of claim 8, wherein the hollow cross section extends from the first ends to the second ends.

11. The fan shroud of claim 8, wherein the fan mounting plate 20 further comprises a metallic reinforcing member 40.

12. The fan shroud of claim 8, wherein the opening 14 allows air to pass from the first face to the second face.

13. The fan shroud of claim 8, wherein the spiders 18 comprise “V” cross-section.

14. The fan shroud of claim 13, wherein the spiders 18 comprise a hollow double-wall member having at least one hollow chamber.

15. The fan shroud of claim 14 comprising a plurality of chambers.

16. The fan shroud of claim 8, wherein the spiders 18 are formed having an “I” cross section.

17. The fan shroud of claim 16 wherein the spiders comprise a hollow double-wall member having at least one hollow chamber.

18. The fan shroud of claim 17 comprising a plurality of chambers.

19. The fan shroud of claim 8, wherein the motor mounting plate 20 is concentric with the opening 14.

20. The fan shroud of claim 8, wherein a chamber is formed between the first face and the second face.

21. The fan shroud of claim 8, wherein a plurality of chambers are formed between the first face and the second face.

22. The fan shroud of claim 6, wherein the opening 14 extending from the front face of the body to the rear face of the body is substantially circular.

23. A fan motor mount comprising:
a plurality of radially spaced spiders 18 having first ends extending forward and radially outwardly from a motor mounting plate 20, at least a portion of the spider 18 having a hollow cross section, the motor mounting plate 20 having an opening for a motor shaft to extend therethrough, the spiders 18 having second ends terminating in a generally circular band, the motor mounting plate 20 displaced rearwardly from said circular band.

24. The fan motor mount of claim 23, wherein the circular band is generally concentric with an axis of the motor shaft.

25. The fan motor mount of claim 23, wherein the spiders 18 conform generally to an arc between the first end and the second end.

26. The fan motor mount of claim 23, further comprising a securement means to secure said fan motor mount to a fan shroud.

27. A method of forming reservoirs, comprising the steps of:
inserting a parison in a mold cavity;
sealing the parison at opposing ends to form a central cavity;
supplying a pressurized fluid to the central cavity, whereby the parison conforms to a shape of the mold cavity;
forming a pinch line delineating a first reservoir 36 from a second reservoir 10, the first reservoir 36 formed within a perimeter of the second reservoir.

28. The method of claim 27, further comprising the step of separating said first and second reservoirs.
